(19) United States
(12) Patent Application Publication
(10) Pub. No.: US 2026/0212614 A1
(43) Pub. Date: Jul. 23, 2026

(54) Wearable-Based Platform for Collaborative Crowd-Sourced Media Insights and Predictions

(71) Applicant: Cherif Algreatly, Fremont, CA (US)

(72) Inventor: Cherif Algreatly, Mountain View, CA (US)

(21) Appl. No.: 19/418,978

(22) Filed: Dec. 13, 2025

Related U.S. Application Data
(60) Provisional application No. 63/747,000, filed on Jan. 21, 2025.

(51) Int. Cl. G06T 19/00; G02B 27/01; G06N 5/02; G06V 20/40; G06V 20/52

(52) U.S. Cl. CPC G06T 19/006; G02B 27/017; G06N 5/02; G06V 20/44; G06V 20/52; G06T 2219/024

(57) ABSTRACT

A system for crowd-sourced media insights and predictive analysis is disclosed. Electronic devices capture media representing a real-world environment and associate it with user-generated insights. A processing unit converts the media into unique identifiers to store and retrieve these insights from a database, enabling users to access shared knowledge by capturing similar content. Additionally, the system analyzes live-streamed video using machine learning to predict subsequent events and transmit alerts or predictive insights to the user in real-time.

### CROSS-REFERENCE TO RELATED APPLICATION

This application claims the benefits of U.S. Provisional Patent Applications No. 63/747,000, filed Jan. 21, 2025.

### BACKGROUND

Smart glasses have become widely available in recent years, revolutionizing how we interact with technology in our daily lives. Most smart glasses are equipped with advanced features, including a camera for capturing high-quality photos and recording videos, a microphone for enabling voice commands and hands-free communication, and a speaker for listening to sounds, notifications, or music. These devices combine functionality and convenience, making them ideal for various applications such as augmented reality (AR), navigation, real-time language translation, and even fitness tracking. With their lightweight design and seamless integration with smartphones and other devices, smart glasses are not just a tool but a gateway to a more immersive and interactive experience. Their versatility makes them valuable in both professional settings, such as medical procedures and construction sites, and in everyday activities, like capturing memories or enjoying entertainment on the go.

Until now, the widespread adoption and impact of smart glasses have been limited, largely confined to minor or niche applications. This has resulted in a significant gap between the technology's potential and its actual contribution to critical sectors. For example, in healthcare, where real-time collaboration and augmented support could save lives; education, where immersive and collaborative learning can revolutionize the classroom; workplaces, where enhanced collaboration and real-time insights can boost efficiency; training programs, where realistic simulations and collaborative learning can improve skill acquisition; and productivity, where seamless task management and integration can optimize performance-these vital sectors have yet to fully realize the transformative potential of smart glasses for collaborative purposes.

To enable smart glasses to effectively serve critical fields that require collaboration, such as healthcare, education, work, training, and productivity, several technological advancements are necessary. One key development is the integration of advanced augmented reality (AR) capabilities. This would allow smart glasses to provide precise, real-time overlays of information, such as anatomical visuals for surgeons, interactive educational content for students, or step-by-step guides for technicians working on complex machinery. By enhancing the delivery of context-specific information, AR can bridge the gap between theoretical knowledge and practical application. In such cases, cloud-integrated collaboration platforms also hold immense potential for smart glasses. By enabling seamless data sharing and live interactions, these platforms could revolutionize remote work and education. Specialists in healthcare could consult remotely with annotated AR visuals, while globally connected classrooms could engage in shared lessons with interactive tools. For the workforce, live feeds and shared AR spaces could bridge geographical barriers, fostering more efficient teamwork.

In fact, achieving this requires the development of an entirely new technology of collaboration platforms that go beyond traditional methods. These platforms must seamlessly integrate advanced technologies such as real-time augmented reality (AR), context-aware, and interactive environments. They should enable users to work together in immersive spaces, whether in the same physical location or remotely, ensuring effective communication, data sharing, and decision-making in real time. Furthermore, these platforms must prioritize scalability, security, and user-centric design to address the unique needs of critical sectors such as healthcare, education, training, and professional work environments.

### SUMMARY

The present invention discloses a system for collaboration utilizing smart glasses or smart contact lenses. This innovative system enables users to seamlessly collaborate, share knowledge, insights, and learning based on their real-time experiences in daily life. By leveraging advanced wearable technology, users can interact and exchange information in an intuitive, hands-free manner. The system offers real-time sharing capabilities, allowing users to stream their live view directly to collaborators. This enables others to see through their perspective and engage in meaningful interaction. Integrated comment or insight tools enhance this functionality by allowing users to highlight objects or areas of interest in real-time, creating an interactive and dynamic experience. One of the standout features is the use of augmented reality (AR) overlays. These overlays display contextual information, such as instructions or live data, directly over the user's view. Collaborators can contribute to the experience by adding virtual notes or labels, visible to all participants through the smart device. This ensures that communication is precise, actionable, and visually engaging.

The system is designed for hands-free operation with voice commands and gesture recognition, making it user-friendly even in dynamic or high-pressure environments. It supports multi-user collaboration, allowing several users to connect in a shared virtual space where everyone can contribute insights and inputs. This feature is particularly useful for team-based problem-solving or remote mentoring. Cross-device compatibility further enhances the system's versatility, enabling synchronization with smartphones, tablets, and desktop systems. Additionally, the system prioritizes user privacy and security, employing encrypted data transmission to ensure secure communication and protect sensitive information. Practical applications of this system span various fields. In education, teachers can guide students remotely using AR content and step-by-step instructions. Healthcare professionals can collaborate during surgeries or receive AR-assisted instructions for medical equipment setup. In the workplace, engineers and construction teams can troubleshoot issues by sharing visuals and receiving instant feedback from remote experts. Similarly, individuals in daily life can benefit from this system, such as travelers sharing experiences or home enthusiasts receiving real-time guidance.

This collaboration system is a transformative tool that enhances teamwork, innovation, and problem-solving across industries. By integrating smart glasses and other devices, it enables real-time perspective sharing and AR-enhanced insights, breaking down barriers of distance and accessibility. From revolutionizing education and healthcare to enhancing engineering and entertainment, its applications are vast and impactful. With its intuitive, hands-free interface, the system fosters productivity, creativity, and deeper connections. It redefines collaboration norms and blends physical and digital realms, opening the door to smarter, more connected communities and a future of limitless possibilities. This collaboration system not only transforms how people work and connect but also inspires new possibilities for innovation and creativity. By bridging the gap between technology and human interaction, it paves the way for a smarter, more interconnected future.

### BRIEF DESCRIPTION OF THE DRAWINGS

FIG. 1 is a block diagram illustrating the main components of the collaborative system, according to one embodiment.

FIG. 2 illustrates the types of media files generated by the electronic devices.

FIG. 3 illustrates an exemplary electronic device configuration comprising a camera, microphone, recorder, speech-to-text program, display, and speaker.

FIG. 4 depicts smart glasses capturing an image of an object located within the camera's field of view.

FIG. 5 depicts smart glasses presenting visual or audio insights related to the captured object.

FIG. 6 is a block diagram of the collaborative, crowd-sourced media insight system according to one embodiment.

FIG. 7 illustrates identifier generation using object, event, voice, sound, and music recognition technologies.

FIG. 8 illustrates a server analyzing live video streamed from a device to store content descriptors, predict subsequent events, and transmit predictive alerts.

FIG. 9 is a flowchart illustrating the method of crowd-sourced media content creation, retrieval, and transmission.

### DETAILED DESCRIPTION

In a first embodiment of the present invention, the camera of the smart glasses captures an image of an object. This image is then transmitted to a server for processing. The object can be any physical entity, such as a product, vehicle, machine, building, planet, food, animal, human, or any other tangible item. The object can also encompass any printed or digital text or image, including those found in books, magazines, newspapers, or displayed on electronic devices like computers, tablets, and smartphones. Essentially, the object can be anything visible to the user while wearing the smart glasses. The server is equipped with a computer vision program designed to identify and classify the object within the image, assigning it one or more keywords. The server also maintains a database containing a list of object keywords, organized alphabetically. Each entry in the database is associated with a corresponding content. Upon receiving an object keyword from the image processing, the server searches its database using this keyword. The content associated with the identified keyword is then retrieved and transmitted back to the smart glasses for display to the user. With image transfer, users can add insights to images before sending them to the server. These insights are then stored in the database and become available to the user and other users who send similar images.

In a second embodiment of the present invention, the camera and microphone of the smart glasses records a video of an event and transmits this video to a server for processing. The video can be any recording that captures a sequence of actions or occurrences over a period of time. Essentially, the video encompasses any recording of events observable by the user through the smart glasses. The server utilizes a computer vision program and a speech-to-text program to analyze the video and generate a list of successive keywords that represent the events depicted in the recording. The server also maintains a database containing groups of successive keywords, with each group associated with a specific content. Upon receiving a particular group of keywords from the video processing, the server searches its database for a matching group. The content associated with the identified group of keywords is then retrieved and transmitted back to the smart glasses for display to the user. It's important to note that a video can be a recording of visual events alone, visual events with accompanying conversation, or conversation only (an audio recording with no visual component). In all these cases, the video is converted into a number of successive keywords representing its key elements. These successive keywords may reflect the visual events depicted in the video, the combined visual events and conversation within the video, or the conversation captured in the video. With video transfer, users can add insights to videos before sending them to the server. These insights are then stored in the database and become available to the user and other users who send similar videos.

In a third embodiment of the present invention, the microphone of the smart glasses records a person's voice. The server is equipped with voice biometrics technology to convert the voice into a voice code representing the unique voice characteristics. The server maintains a database containing a list of different voice codes, each associated with a content. Upon receiving a voice code, the server searches its database using this code and retrieves the content associated with that specific voice code. The content is then sent to the smart glasses to be displayed to the user. The person's voice could be also different sounds generated in nature, such as birdsong, animal calls, ocean waves, river rushes, rainfall, wind, thunder, earthquakes, volcanoes, and the cracking of ice. In this case, the server is equipped with a sound recognition technologies that leverage AI techniques, such as machine learning and deep learning, combined with digital signal processing methods and data science principles. In such a case, the database contain a list of different sound codes, each associated with a specific content to be sent to the smart glasses once the sound code is received. It is important to note that the database is classified according to sound level, such as low, medium, high, and extremely high, to indicate different content associated with each sound level. With a person's voice recording transfer, users can add insights to the recording before sending it to the server. These insights are then stored in the database and become available to the user and other users who send a recording to the same person's voice.

In a fourth embodiment of the present invention, the microphone of the smart glasses records a music. The server is equipped with a technology for recognizing music such as music fingerprinting to convert the music into a music code representing the recording. The server maintains a database containing a list of different music codes, each associated with a content.

Upon receiving a music code, the server searches its database using this code and retrieves the content associated with that specific music code. The content is then sent to the smart glasses to be displayed to the user. It is important to note that music can encompass other forms of expression, such as sound effects used in movies, games, and other media to create atmosphere and evoke emotions, or speech that possesses rhythm, melody, and even harmony (such as in spoken word poetry). In such cases, the server is equipped with suitable technology to recognize sound effects or to analyze the rhythm, melody, and harmony of speech. With a music recording transfer, users can add insights to the recording before sending it to the server. These insights are then stored in the database and become available to other users who send the same music recording. With a music recording transfer, users can add insights to the recording before sending it to the server. These insights are then stored in the database and made available to the user and other users who access the same music recording.

According to the first, second, third, and fourth embodiments of the present invention, the smart glasses can capture a picture, record a video, record a sound, and record music. This data is then sent to the server. The server contains a first database for pictures, a second database for videos, a third database for sounds, and a fourth database for music. Each element within each database has a unique identifier associated with its content. The content could be text, image, video, voice, sound, or music. However, all this content is provided by users of the smart glasses. For example, according the first embodiment of the present invention, a user who capture a picture of an object can send the object picture to the server, associated with new content to be stored in the database under the object keyword/s. This new content could be text, image, video, voice recording, or music recording. Also, according the second embodiment of the present invention, a user who record a video can send the video to the server, associated with new content to be stored in the database under the video successive keywords. This new content could be text, image, video, voice recording, or music recording. According the third embodiment of the present invention, a user who record a voice or natural sound audio, can send the recording to the server, associated with new content to be stored in the database under the video code. This new content could be text, image, video, voice recording, or music recording. Similarly, according the fourth embodiment of the present invention, a user who record a music, can send the recording to the server, associated with new content to be stored in the database under the music code. This new content could be text, image, video, voice recording, or music recording.

The new content of the user can be provided by voice input through the smart glasses'microphone. This voice input is then converted to digital text using a speech-to-text program. Also, the new content of the user can include voice recordings that are stored in the database as-is, and sent to other users as voice recordings, not as text. Additionally, the new content of the user can be a video selected from sources stored on the smart glasses or any devices connected to the smart glasses via Bluetooth or Wi-Fi, such as a smartphone or a computer. Usually, the new content represent user's insights about the object picture, video, voice or sound recording, or music recording. For example, a first user captures a picture of the George Washington Bridge in New York, may send this picture to the server with their own insight about this bridge. These insights are stored in the database associated with the picture of the George Washington Bridge. When a second user captures a picture of the George Washington Bridge, the insight of the first user is sent from the server to the display of the smart glasses of the second user to be displayed. In this case, the second user can provide feedback on the first user's insight or offer new insights. It is important to mention that the pictures of the first and second users should not be from the same point of view, since the object recognition program will identify the object in the picture regardless of the camera point of view. The same concept applies to videos. For example, when a first user records and uploads a video to the server that includes footage of an old man running and then falling due to a stone obstacle, and a second user uploads a video featuring a child running and then falling because of a tree, the second user can receive the insight of the first user that are associated with the first video. This happens because both videos share similar successive keywords. In this case, the successive keywords for the first video might be ‘old man,’ ‘running,’ and ‘falling,’ while the successive keywords for the second video could be ‘child,’ ‘running,’ and ‘falling.’ AI programs equipped with large language models can detect the relationship between the two groups of the successive keywords of the two videos and draw meaningful connections.

The picture and insights sent from the smart glasses to the server may include additional information beyond just the image and its associated insights. For instance, the location of the image can be transmitted if the smart glasses are equipped with GPS, or if a device connected to the smart glasses via Bluetooth or Wi-Fi has GPS capabilities. The location could be used as a filtering criteria in seeing the insights based on geographical zones. For example, for a picture of a certain car brand, the user may need to see only the insights about this car based on certain users'location, for example, from users in the same city or country. Location-based filtering applies to videos, voice or sound recordings, and music recording. For example, insights about a piece of music could be filtered according to a region or country if the user prefers that. However, insight filtering can be extended to other factors, such as age, gender, occupation, education, interests, background, or demographics, if this information is provided by the user during profile creation before using the present invention.

The filtering factors can include elements other than the GPS location or the user's profile information. These factors are identified through analysis of the data from pictures, videos, voices, sounds, or music that are sent to the server. For example, in pictures, the surrounding elements or environment of the main object in the picture can be used as filtering criteria. A picture of a famous landmark could show this landmark in day, night, during rain, or snow. The user might be interested in seeing the insights of other users who captured images of this landmark during night or during snow. Also, in videos that show people running and then falling down, the user may be interested in seeing the insights of videos where the running person was old, young, healthy, unhealthy, happy, or sad. Such words could already exist in the video's successive keywords, which would allow filtering based on these criteria. This applies to voice, sounds, and music recordings. For example, insights stored about a person's voice could include the tone of that person when they are happy, sad, excited, or depressed. Also, insights about a tiger's sound could include the tone of the tiger if it is angry, hungry, or relaxing. Recordings of the same piece of music could include descriptions of the music's location or environment, such as in an open-area concert (based on the crowd sounds) or at home (based on salient background sounds in the recording).

Generally, the present invention enables smart glasses users to capture pictures, record videos, audios, or music and receive real-time insights about the content of those media. A user's insights about uploaded media are sent to the server and made available to them and other users uploading the same media. When the user saves a picture, video, audio, or music with their insights on their smart glasses album or gallery, these insights are updated each time a user sends new related insights. Consequently, whenever the user accesses their album or gallery to open a picture, video, or audio, the updated insights are displayed with the opened media. Having updated insights displayed with pictures, videos, and audio files offers several significant advantages. Firstly, it enhances context and understanding. These insights provide additional information, enriching the viewing experience. For example, if a user captures a picture of a landmark, updated insights could offer historical information or current events related to that location. This can also act as a valuable memory aid, reminding users of important details or events associated with the captured media. Secondly, it improves discoverability and organization. Updated insights can be used to tag and categorize media, making it easier to search for and retrieve specific files. This contributes to a more organized and personalized digital library. Also, it personalizes the user experience. Insights can be tailored to individual interests and preferences, offering unique perspectives and interpretations of the media. This fosters a deeper appreciation for captured experiences and facilitates better communication and sharing with others. In conclusion, having updated insights displayed with media enhances the user experience by providing richer context, improving organization, and creating more personalized and meaningful interactions with digital content.

Generally, the present invention generates interactive crowdsourced content for media by identifying and analyzing objects in pictures, events depicted in videos, individuals in voice recordings, natural sounds in audio recordings, and musical pieces or songs in audio files. This crowdsourced content is updated whenever users provide new insights, creating continuously updated and dynamic content. Moreover, the results of the search in this interactive crowdsourced content provide unique outcomes and features that are not available in any current search engines, such as Google or Bing.

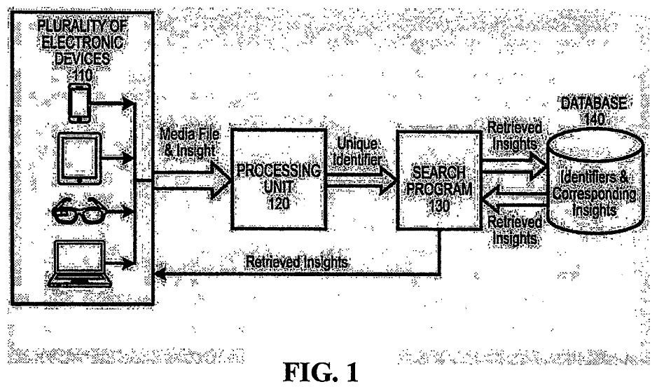

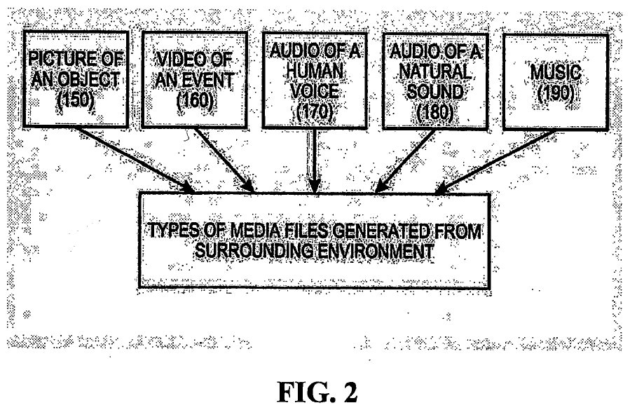

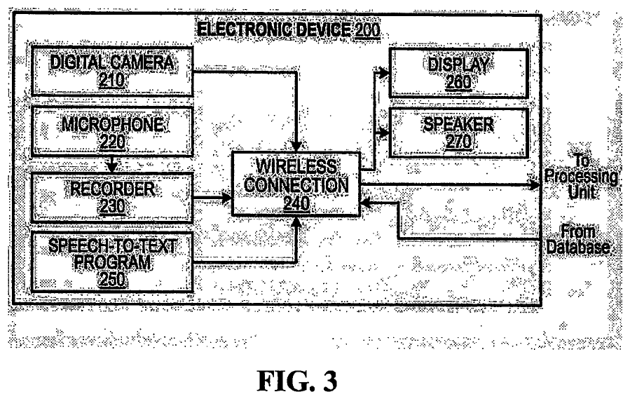

According to one embodiment, FIG. 1 illustrates a block diagram for the main components of the present invention. As shown, a plurality of electric devices 110 each of which is capable of generating a media file from the surrounding environment, and associating the media file with an insight or feedback. All electronic devices are connecting to a processing unit 120 that receives each media file and converts it into a unique identifier representing the media file content. The processing unit sends the identifier to a search program 130 that searches a database 140 that stores each unique identifier with corresponding insights. The corresponding insights are retrieved from the database and sent to the electronic device that sent the media file. FIG. 2 illustrates the types of media files that can be generated from the surrounding environment. As shown in the figure, each media file can be a picture 150 of an object, a video 160 of an event, an audio of a human voice 170, an audio of a natural sound 180, or a music 190. To capture the pictures or record the videos or audios, FIG. 3 illustrate a block diagram of an electronic device 200 equipped with a digital camera 210 to take pictures or record videos, microphone 220 and recorder 230 to record the voices, sounds,, or music, and a wireless connection 240 to send the pictures, videos, and voices, sounds, or music recordings to the processing unit. The electronic device is also equipped with a speech-to-text program 250 that converts the user's vocal insights into digital text to be sent with the picture, video, or audio. The camera, microphone, recorder, and speech-to-text program are used as input tools for the present invention. To receive the insights output of the database and present them to the user, the electronic device is also equipped with a display 260 and a speaker 270. The display present the visual output such as digital text, images, or videos, while the speaker plays audio. As mentioned previously, the insights of the user that are sent to be stored in the database could be text, images, videos, or audios. That explains the need for a display and a speaker in each electronic device to present the coming insights of the database.

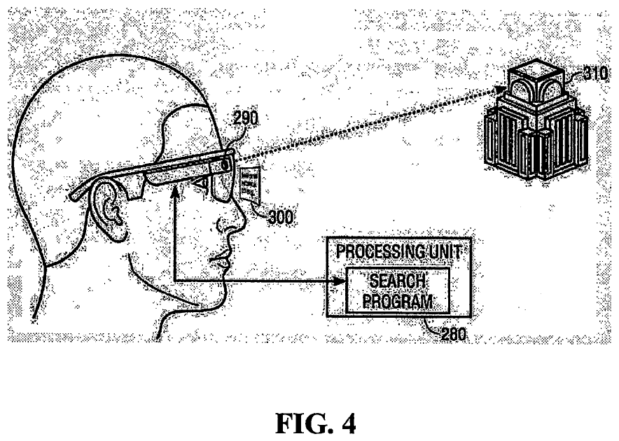

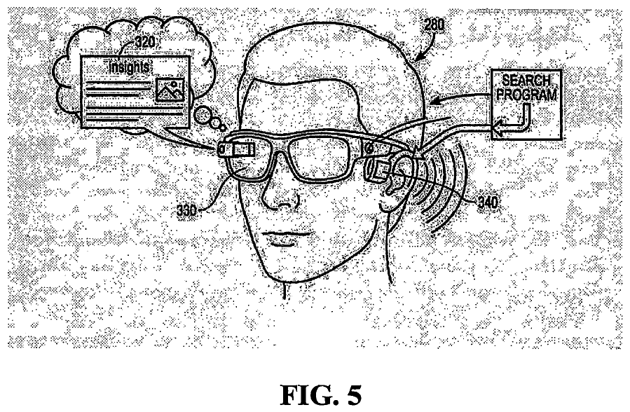

FIG. 4 illustrates a smart glasses 280 with a camera 290 and a display 300 where an object 310 is located in front of the camera. The camera takes a picture or records a video for the object to be sent to the processing unit. Once that happens, the search program sends corresponding insights about the object to the electronic device. As shown in FIG. 5, the insights 320 received from the search program are presented on the display 330 of the smart glasses, in case of the insights are digital text, pictures, or videos. Also, the insights received from the search program are played on the speaker 340 of the smart glasses, in case of the insights are voice, sound, or music recording. It is important to note that the electronic device could be smart glasses, smart contact lenses, smartphone, tablet, or any electronic devices that equipped with a camera, microphone, speaker, and display. A GPS is an additional component of the present invention in case the geographical location of electronic devices is needed for certain applications and uses.

In one embodiment of the present invention, the pictures, videos, or recordings are captured at the time selected by the user. In another embodiment, the pictures, videos, or recordings are continuously captured and sent to the server. In this case, the insights are sent according to the user's preferences. For example, the insights could be sent when the user is exposed to a danger. This danger could be indicated by an object appearing in a picture, an event occurring in a video, or a voice or sound detected in an audio recording. Another example, the insights could be sent if they are related to something humorous that the user is seeing or hearing, or when a decision needs to be made. Receiving insights on the user's smart glasses in moments of danger, sadness, or when they need a boost of happiness or the like offers numerous advantages. In situations of danger, real-time alerts and notifications can warn the user of potential threats, guide them to safety, or connect them with emergency services, ensuring their safety is prioritized. For moments of sadness, personalized support like inspirational quotes, positive affirmations, or reminders of joyful memories can provide comfort and uplift the user's mood. These insights can also connect the user to mental health resources or prompt the user to reach out to their support network. When the user needs a boost of happiness, contextual humor, uplifting content, or motivational messages tailored to the user's preferences can brighten their day and inspire positivity. Furthermore, insights can be especially valuable when a decision must be made, offering timely and relevant information to help the user to choose the best course of action. By offering context-sensitive guidance and personalized content, these insights help the user make better decisions, avoid danger, and manage emotions effectively, providing seamless support to enhance the user's overall well-being.

According to the previous description, the present project discloses a system to present crowd-sourced media content on smart glasses. The system comprising; a plurality of electronic devices each of which capable of creating a media file representing a surrounding environment and send the media file with insights to a processing unit; a processing unit that receives the media files and the insights to convert the media files into identifier representing the content of the media file; a database that associates each unique identifier with related insights; and a search program that receives the identifier and searches the database to retrieve the insights corresponding to the identifier and send the insights to the electronic device that sent the media file.

The electronic devices of the present invention can be smart glasses equipped with features designed to enhance functionality, interactivity, and the overall user experience of the present invention. The components of the smart glasses include cameras, microphones, and speakers, and advanced display technology. It could feature augmented reality (AR) displays that overlay digital information onto the real world using transparent lenses or waveguides, or employ heads-up displays (HUDs) to project the insights of the present invention directly into the user's field of view. To support seamless interactions, the smart glasses could integrate various sensors such as accelerometers, gyroscopes, and magnetometers track head movement and orientation, enabling precise AR interactions. Proximity sensors to detect when the glasses are worn, while ambient light sensors adjust display brightness for visibility in different lighting conditions. GPS and location sensors provide navigation and location-based services, adding to their versatility. The smart glasses could include Bluetooth for pairing with devices, Wi-Fi for internet access, and, in some cases, cellular connectivity (4G/5G) for standalone operation. For user input, the smart glasses offer multiple methods such as swipe controls, voice commands, gesture recognition, and even eye tracking, enabling a hands-free and intuitive experience.

Audio technology in the smart glasses is also included. Bone-conduction technology could be used to transmit sound through vibrations on the skull, leaving the ears open to ambient sounds. Noise-canceling microphones could also be included to improve call quality and voice recognition in noisy environments. Also, spatial audio can be included to provide an immersive sound experience, particularly useful for AR or VR applications. The smart glasses are powered by rechargeable batteries that are integrated into the frame, offering varying lifespans. Cameras could become more sophisticated, with some glasses featuring multiple lenses for stereoscopic vision, 3D mapping, or depth sensing. Infrared cameras enable functionality in low-light environments, and LIDAR or depth sensors support advanced AR mapping. These glasses can run on custom or Android-based operating systems, often integrated with platforms like ARKit (Apple) or ARCore (Google). Companion apps provide users with customization options, and enterprise applications include real-time translation, remote collaboration, and live video sharing. Privacy features, such as LED indicators that signal when the camera is active, address concerns about surveillance, while biometric authentication methods like fingerprint scanning or voice ID ensure secure use. Design and comfort are also priorities, with lightweight frames made from materials like titanium or carbon fiber. Adjustable nose pads and temples ensure a comfortable fit, and some models accommodate prescription lenses. The smart glasses could be designed to be water and dust-resistant.

The electronic device of the present invention could be modern smart contact lend. The smart contact lenses integrate advanced technologies into the compact and flexible form factor of a traditional contact lens. These lenses are equipped with micro-LED or OLED displays to project information directly into the wearer's field of view, enabling functionalities like augmented reality (AR) overlays, navigation assistance, or real-time health monitoring. To enhance the user experience, waveguides or holographic optics direct light precisely to the retina, creating immersive visuals without obstructing natural vision. At the core of smart contact lenses are various sensors designed for multiple applications. Biometric sensors monitor health metrics such as glucose levels, intraocular pressure, and hydration, while motion and position sensors track eye movements for hands-free control and interaction with AR systems. Environmental sensors also play a role, detecting factors like ambient light, UV exposure, or air quality, allowing the lens to adjust display brightness or provide relevant alerts. Powering these lenses is a sophisticated energy system that includes micro-batteries, wireless power transfer through inductive charging, and energy storage layers. These components are designed to provide sufficient energy for the lens's functionalities while maintaining its thin and lightweight structure. Connectivity is another critical feature, with wireless communication modules such as Bluetooth, Wi-Fi, or NFC enabling seamless integration with smartphones and other devices.

In addition to smart features, many lenses offer optical benefits. Some function as prescription lenses for vision correction, while advanced versions incorporate adjustable focus using electroactive materials or liquid lenses. Integrated circuits, including miniaturized circuit boards and custom ASICs, manage processing and data handling without adding significant bulk. Some prototypes even include miniature cameras for object recognition, augmented reality applications, and low-light imaging, often enhanced by infrared (IR) sensors. The materials used in the smart contact lenses are biocompatible, ensuring comfort and safety for wearers. Hydrogel substrates provide moisture retention and breathability, while flexible electronics are embedded seamlessly within the lens. Anti-bacterial coatings help reduce the risk of infections, enhancing the overall hygiene and practicality of these lenses. Advanced features further expand the capabilities of smart contact lenses. They can non-invasively monitor glucose levels in tear fluid for diabetic patients or administer medication directly to the eye for conditions like dry eye or infections. Some lenses include UV filters for eye protection, and augmented reality capabilities allow for gaming, training, or navigation applications. Emerging designs aim to incorporate holographic projection systems, AI-driven health diagnostics, and even brain-computer interface integration. Despite challenges such as miniaturizing components, improving energy efficiency, and ensuring long-term comfort, smart contact lenses represent a promising leap forward in healthcare, augmented reality, and personal connectivity. Their ability to seamlessly integrate advanced technology into daily life has the potential to revolutionize how people interact with the world around them.

The electronic device used in the present invention could be a smartphone, tablet, or handheld device equipped with a camera, microphone, speaker, and virtual keyboard. The virtual keyboard can be used for typing insights as an alternative to voice input. The media files of the present invention could include pictures, videos, or audio recordings containing voices, sounds, or music. The surrounding environment could be any outdoor or indoor space where the user is located while capturing the pictures or recording the videos or audio. The insights could be in the form of text, images, or videos. The processing unit is a computer technology that utilizes computer vision for processing pictures and videos, or AI audio technology for processing voice, sound, or music recordings. The search program is a computer program that searches the database and retrieves the stored insights associated with the new identifier. The search can utilize the location of the user when using a GPS with the electronic device. The user's location makes the annotation more related to the user's surrounding environment. For example, when the user's location matches that of a specific restaurant, and the camera of the present invention captures an image of a food menu, the insights provided could be limited to the food offered at that restaurant. This simplifies the search program's process in retrieving relevant insights from the database. It is important to note that the camera of the present invention can capture only a part of an object. In such cases, the insights displayed to the user will relate specifically to the captured part. For instance, capturing an image of a bird's beak or foot will provide insights related to that specific part of the bird. This feature ensures that users of the present invention receive highly specific and relevant insights.

The present project serves a diverse range of fields and applications, including sports, gaming, work environments and productivity, healthcare, elder care, education, training, security, media, communication, entertainment, travel, tourism, law enforcement, transportation, manufacturing, construction, maintenance, the Internet of Things, smart homes, and telecommunications fraud detection. More information about each use and application is provided in the following descriptions.

The present invention revolutionizes sport spectating by enabling real-time collaboration through smart glasses. Using the glasses'camera, users can capture live footage, provide insights about players, coaches, referees, and in-game events, and share them instantly via cloud synchronization. Others can view these insights, comment, and add their own, transforming passive viewing into an engaging and interactive experience. The glasses also feature player recognition, allowing users to focus on specific athletes and their performance, with voice commands simplifying the creation of insights. Ideal for live stadium viewers, this technology fosters community interaction during pivotal moments and enhances enjoyment for all types of sports, including basketball, soccer, boxing, football, tennis, cricket, hockey, baseball, gymnastics, and track and field. By blending augmented reality and collaboration, it delivers richer insights for fans, players, and analysts, innovating how sports are experienced.

The present inventions redefines sports broadcasting by enhancing viewer engagement through crowd-sourced insights, instant replays, and interactive participation. Fans can actively interact with broadcasts by tagging players, discussing key moments, and contributing to a collaborative viewing experience, with real-time insights created and viewed directly through smart glasses. These insights are seamlessly shared among users, fostering collaboration while supporting features like personalized filters, replay options, and grouped insights. Ideal for live games on TV, computers, or mobile devices, the system enriches traditional broadcasts for major sports like football, basketball, and soccer, while offering tailored features for niche sports such as cycling, surfing, or archery. Smart glasses can capture live footage, identify individual players, and enable users to add insights, which are instantly synced to the cloud and accessible to others focusing on the same player. By transforming the viewing experience, this technology enhances fan engagement, delivers real-time insights, and offers personalized content, interactive participation, and innovative storytelling, while also opening new opportunities for advertisers.

This present invention revolutionizes gaming by transforming how players and spectators engage with virtual worlds through real-time collaboration and crowd-sourced insights. Smart glasses enable users to annotate in-game characters, objects, and events, fostering an interactive and immersive gaming experience. Players and viewers can tag in-game elements with insights, comment on existing annotations, or create new ones during live gameplay or from past sessions, enriching the overall experience. Ideal for eSports tournaments, multiplayer online games, and live streaming platforms, the technology thrives in competitive games like League of Legends and Call of Duty, as well as sandbox games like Minecraft and Roblox. By enhancing player and spectator engagement, it offers personalized interactions, collaborative gameplay, and innovative storytelling opportunities. Game developers can leverage this system to build communities and create new monetization avenues. Smart glasses capture live gameplay footage and recognize in-game characters or objects, enabling users to add voice-activated insights that are instantly uploaded as text to the cloud and shared with others when they focus on the same elements, revolutionizing the gaming experience.

The present invention transforms productivity and collaboration in work environments by enabling real-time and crowd-sourced insights. With smart glasses, users can annotate documents, designs, or physical objects in the workspace, creating an interactive and shared experience among team members. Users can tag work-related materials like documents, blueprints, or prototypes with insights, allowing others to view, comment, or add new annotations. This enhances collaboration, improves understanding, and supports real-time decision-making. Ideal for workplaces requiring high levels of teamwork-such as design studios, construction sites, and corporate offices-the technology is particularly effective for reviewing design drafts, brainstorming sessions, training programs, and quality inspections. By enabling dynamic collaboration, it streamlines feedback processes, connects teams across locations, and integrates additional context or resources directly into the workspace. Smart glasses recognize documents, designs, or objects being viewed, allowing users to add voice-activated insights that are instantly synced to the cloud. These insights are accessible to others when they interact with the same materials, revolutionizing traditional workflows and boosting productivity.

The present invention transforms virtual meetings by introducing real-time collaboration and crowd-sourced insights, enhancing engagement and productivity. Using smart glasses, participants can annotate shared screens, documents, or virtual whiteboards, creating an interactive and dynamic meeting environment. Users can tag and annotate meeting content-such as slides, documents, or live video feeds-and share insights that others can view, comment on, or expand. Ideal for remote team meetings, training sessions, and brainstorming workshops, this technology supports collaboration in corporate settings, educational environments, and project discussions. It ensures active participation, streamlines feedback, and promotes decision-making. By turning traditional virtual meetings into engaging, interactive experiences, it provides organizations with a platform for capturing collaborative insights and improving outcomes. Smart glasses recognize shared content during meetings, such as presentations or video streams, enabling participants to add voice or text insights that are instantly synchronized to the cloud, allowing seamless interaction and enhanced collaboration for all attendees.

The present invention revolutionizes training and development by enabling real-time collaboration and interactive learning experiences. Using smart glasses, trainers and trainees can annotate instructional materials, live demonstrations, and training modules, fostering an engaging and effective learning environment. Participants can add insights to training materials, such as videos, presentations, or live sessions, including additional explanations, questions, or feedback, which supports collaborative learning and immediate clarification. Ideal for corporate training programs, technical skill development, and hands-on workshops, the technology enhances engagement during live sessions, streamlines onboarding processes, and ensures consistent, interactive instruction across distributed teams. By transforming training into a dynamic and personalized experience, it improves knowledge retention, promotes collaborative problem-solving, and ensures uniform delivery of content. Smart glasses capture training sessions and recognize key elements, such as visuals, text, or equipment, allowing users to add voice or text-based insights that are instantly uploaded to the cloud and shared in real time, ensuring seamless collaboration and feedback for all participants.

The present invention revolutionizes healthcare collaboration by enabling real-time interaction and insights sharing among medical professionals. Using smart glasses, doctors, nurses, and other healthcare staff can annotate patient charts, medical imaging, or live procedures, creating a more efficient and connected care environment. Healthcare professionals can tag and annotate medical documents, images, or live video streams during consultations or procedures, with insights synchronized in real time to allow team members to view, comment, or contribute additional input. Ideal for telemedicine consultations, collaborative diagnostic reviews, and training in surgical or medical procedures, this technology enhances teamwork in complex cases, streamlines communication across departments, and supports medical education. By transforming traditional workflows, it improves communication, reduces decision-making time, and ensures more accurate diagnoses. Smart glasses capture patient records, medical scans, or live video feeds, enabling healthcare professionals to add voice-activated insights that are instantly uploaded to the cloud and shared across the care team, fostering collaboration, promoting knowledge sharing, and ultimately enhancing patient care.

The present invention revolutionizes surgical collaboration by enabling real-time communication and insights sharing during procedures. Using smart glasses, surgeons and medical teams can annotate live surgical visuals, medical instruments, and patient data, creating a highly coordinated and efficient surgical environment. The technology allows surgeons and team members to tag and annotate live feeds of procedures, medical imaging, and patient monitors, as well as medical instruments or specific procedural steps, ensuring clarity and precision throughout the operation. Ideal for complex surgeries, remote assistance, and training, it enhances communication during minimally invasive procedures, supports coordination in multi-disciplinary surgeries, and serves as a valuable tool for teaching surgical techniques. By improving precision, reducing errors, and streamlining communication, the technology fosters better teamwork and collaboration. Smart glasses capture live surgical visuals, instruments, and patient data, enabling surgeons and assistants to add voice-activated insights that are instantly uploaded to the cloud and shared in real time, ensuring seamless collaboration and improved surgical outcomes.

The present invention transforms elderly care by enabling real-time communication, monitoring, and insights sharing among caregivers, healthcare professionals, and family members. Using smart glasses or compatible devices, caregivers can annotate health records, daily activities, and vital metrics, creating a connected and collaborative care environment.

Caregivers can tag and annotate details about a resident's health status, medications, or activities, as well as assistive devices, care procedures, or medical instruments, ensuring clear communication across care teams and with family members. Ideal for residential care facilities, home care services, and family caregiving, this technology supports medication management, chronic condition monitoring, and seamless collaboration among all stakeholders. By improving communication, ensuring accurate documentation, and fostering teamwork, it greatly enhances the quality of care. Smart glasses capture live visuals of care activities, health readings, and daily routines, allowing caregivers to add voice-activated insights linked to specific tasks or metrics. These insights are instantly uploaded to the cloud, enabling real-time access and collaboration for improved elderly care outcomes.

The present invention revolutionizes educational environments by enabling real-time interaction, insights sharing, and collaboration among students and educators. Using smart glasses, users can annotate study materials, classroom visuals, and digital content, fostering an engaging and interactive learning experience. Educators and students can tag and annotate textbooks, presentations, lab equipment, or live lessons with explanations, questions, or feedback, supporting collaborative note-taking and deeper understanding. Ideal for classrooms, professional training programs, workshops, and virtual learning, the technology enhances engagement in STEM labs, art studios, and group projects, while bridging geographical barriers for remote training. By fostering active learning and personalized instruction, it encourages student participation, equips educators to clarify complex concepts, and ensures a richer educational experience. Smart glasses capture visuals of lessons, study materials, and classroom activities, allowing educators and students to add voice-activated insights that are instantly uploaded to the cloud, enabling real-time sharing, feedback, and collaboration.

The present invention transforms remote learning by enabling real-time interaction, insights sharing, and collaboration among students and educators, regardless of location. Using smart glasses, users can annotate digital content, virtual lessons, and study materials, creating an engaging and interactive learning environment. Educators and students can tag and annotate digital textbooks, presentations, and virtual whiteboards with questions, notes, or explanations, while also commenting on live or recorded lessons to ensure personalized and interactive learning. Ideal for online classes, virtual tutoring, and hybrid learning setups, the technology enhances engagement during video lectures, group discussions, and self-paced courses by fostering collaboration and active participation. Students can ask questions and clarify doubts in real time, while educators deliver personalized feedback and explanations, ensuring a deeper and more engaging learning experience. Smart glasses capture clear visuals from virtual lessons and study materials, enabling users to add voice or text-based insights linked to specific content. These insights are instantly uploaded to the cloud and synchronized for seamless collaboration among all participants.

The present invention revolutionizes how students and educators interact with textbooks by enabling real-time insights, collaboration, and enhanced engagement. Using smart glasses or compatible devices, users can annotate textbook content, link additional resources, and collaborate with peers, transforming learning into a dynamic and interactive experience. Students and educators can tag and annotate textbook sections—such as chapters, diagrams, or problem sets—with virtual notes, questions, or explanations. These insights can be shared and viewed by classmates or educators, fostering collaboration and deeper understanding. Ideal for classrooms, remote learning, and self-study, the technology enhances comprehension of complex topics by enabling collaborative exploration of challenging sections, supports group study sessions, and helps teachers highlight critical concepts. By transforming traditional textbooks into interactive tools, it links multimedia resources for richer content, encourages shared learning experiences, and provides personalized instruction. Smart glasses capture visuals of textbook pages, recognizing specific sections like diagrams or exercises, and allow users to add voice or text-based insights. These insights are instantly uploaded to the cloud, where they can be accessed and shared with peers or educators to enhance the learning process.

The present invention revolutionizes retail personalization by enabling in-store staff to deliver tailored customer experiences through real-time access to preferences and purchase history. Using smart glasses, retail staff can provide personalized recommendations, exclusive promotions, and customized styling suggestions, enhancing customer satisfaction and fostering loyalty. The technology allows staff to instantly access customer profiles, tag products with tailored offers, and update customer insights after each visit, ensuring an evolving and highly personalized shopping experience. Ideal for luxury boutiques, department stores, and retail chains, it supports personalized styling, product recommendations, and promotions, creating a shopping experience that feels uniquely tailored to each individual. By offering personalized attention, the technology not only improves customer satisfaction but also strengthens loyalty and drives repeat business. Retailers benefit from increased sales, better customer retention, and valuable insights into buying behaviors. Smart glasses enable staff to access a customer's purchase history as they enter the store, suggest products based on preferences, and update the system with new insights, ensuring these updates are synchronized across all store locations for seamless customer experiences.

The present invention transforms inventory management by providing real-time updates and shared access to product details, significantly improving operational efficiency and reducing errors. Using smart glasses or compatible devices, employees can seamlessly annotate, track, and manage inventory. The technology offers real-time access to inventory levels, product locations, and stock movement data. Employees can tag products with detailed insights, instantly update records, and receive automated alerts for low-stock or misplaced items, streamlining stocktaking and simplifying restocking processes. Ideal for warehouses, retail stores, and distribution centers, it is especially beneficial for tracking high-value or perishable items, ensuring proper handling and reducing losses. By improving accuracy, saving time, and minimizing errors, the technology ensures current stock levels, prevents overstocking or stockouts, and enhances collaboration among teams. Smart glasses recognize product boxes or shapes and update the inventory database in real time, while employees can add insights like condition or handling requirements. These updates are instantly synchronized across the system, ensuring seamless and efficient inventory management.

The present invention revolutionizes retail security by enabling real-time identification and tracking of suspected shoplifters across multiple store locations. Using smart glasses, security teams can efficiently monitor activities, respond to potential threats, and reduce losses while enhancing safety. Equipped with facial recognition capabilities, the technology allows real-time identification and tagging of individuals flagged as potential shoplifters, with instant alerts sent to security staff. Insights about suspicious individuals can be shared seamlessly across teams, and the system integrates with surveillance cameras across all store locations for comprehensive monitoring. Ideal for retail chains, department stores, and high-value outlets, this technology supports proactive monitoring, incident documentation, and coordination between on-site and remote security teams. It is particularly effective in preventing theft and maintaining a safe shopping environment. By enabling faster response times, reducing theft-related losses, and enhancing real-time coordination, the technology creates a safer environment for customers and staff while providing valuable data to refine security protocols. Smart glasses allow security personnel to add and synchronize insights about suspicious individuals in real time, ensuring immediate access for the entire team across locations.

The present invention transforms audience engagement with TV shows by enabling real-time collaboration and crowd-sourced insights. Using smart glasses, viewers can annotate entertainers or scenes on-screen, creating a shared and interactive viewing experience. The technology allows viewers to tag TV show entertainers with insights, comment on existing annotations, or create new ones during live broadcasts or on-demand episodes, which appear as AR overlays on or around the TV screen. Ideal for live shows, streaming platforms, and on-demand TV series, it enhances engagement in reality shows, drama series, and even political debate programs, fostering interactive discussions and shared insights. By providing a platform for personalized content and collaborative commentary, the technology strengthens audience communities and encourages active participation. TV networks and streaming services can leverage it to boost engagement and build loyalty. Smart glasses capture the show being watched and recognize on-screen entertainers, enabling viewers to add voice or text-based insights that are instantly uploaded to the cloud. These insights are shared in real time, promoting collaborative viewing and interactive commentary among users.

The present invention revolutionizes social network engagement by enabling real-time collaboration and crowd-sourced insights. Using smart glasses, users can annotate individuals or objects in photos and videos, creating a shared, interactive experience centered around specific moments. The technology allows users to tag social media content-such as pictures and videos-with insights, linking additional information to individuals or objects featured, and adding an interactive layer to the content. Ideal for popular platforms like Facebook, YouTube, Instagram, and TikTok, it enhances engagement by making content more dynamic, capturing user attention, and introducing game-like elements to explore hidden details in scenes. By fostering interactivity, it enriches the user experience, promotes deeper understanding of shared content, and transforms how users engage with media. Smart glasses recognize faces or objects in the social media content being viewed, allowing users to add voice-activated insights that are instantly uploaded to the cloud. These insights are synchronized in real time, enabling collaborative interactions and shared experiences across the social network.

The present invention transforms print media by introducing real-time collaboration and crowd-sourced insights, making static content interactive and dynamic. Using smart glasses, users can provide insight about articles, advertisements, and images in magazines, newspapers, books, brochures, and catalogs, fostering a shared and engaging experience around the content. The technology allows readers to tag print media with insights, highlight key points, or discuss thought-provoking articles and photos. Other users can view, comment on, or add new insights, deepening interaction and understanding. By linking insights to articles or images, it provides additional context, fosters collaboration, and creates new advertising opportunities through augmented reality (AR). Ideal for enhancing engagement with traditional print formats, this technology bridges the gap between physical and digital media. Smart glasses recognize the specific article or image being viewed, enabling users to add voice-or text-based insights that are instantly uploaded to the cloud. These insights are synchronized in real time, allowing other users to access and interact with them when engaging with the same content, revolutionizing how readers experience print media.

The present invention transforms live entertainment by providing real-time insights that enhance audience engagement and deepen the connection with performances. Using smart glasses, attendees can access information about artists, setlists, or behind-the-scenes details, creating an interactive and immersive experience. Users can contribute insights about singers, bands, or dancers in real time, share live reactions, or access exclusive content synchronized with the show. Ideal for concerts, theater productions, live shows, and festivals, the technology enriches storytelling in theater, provides deeper context during musical performances, and creates unique interactive experiences at festivals. By offering personalized content and interactive features, it fosters greater audience engagement and satisfaction. Event organizers can leverage this technology to deliver exclusive experiences and enhance attendee loyalty. Smart glasses capture visuals or audio from the performance and overlay real-time insights, allowing users to interact with or contribute additional insights, which are instantly synchronized across devices for a seamless and connected experience.

The present invention revolutionizes the entertainment industry by streamlining attendee management and enabling event staff to access and share real-time insights, ensuring smooth operations and delivering exceptional attendee experiences. Using smart glass es, staff can coordinate seamlessly by managing guest lists, seating arrangements, and logistical details with real-time updates and collaboration. Staff can also access key attendee information, such as VIP preferences or ticketing details, allowing for personalized and efficient service. Ideal for concerts, festivals, theater productions, and large-scale events, the technology simplifies tasks such as ticket scanning, seating assignments, and backstage operations while enhancing interactions with attendees, such as guiding VIP guests or resolving issues promptly. By improving communication, reducing errors, and ensuring efficient event execution, this technology enables quicker decision-making and a seamless experience for attendees. Smart glasses allow staff to provide and view real-time insights on attendees, guest lists, and seating arrangements, with all updates instantly synchronized across the system to keep the entire team informed and coordinated.

The present invention enhances networking efficiency at social events by enabling users to provide and access real-time insights about individuals they meet, creating personalized connections. Using smart glasses, attendees can access key details about their interactions, making it easier to recall important information and establish meaningful relationships. The technology allows users to share insights about people they meet, without accessing public data, and these insights can be viewed and expanded upon by other attendees, facilitating new networking opportunities. Ideal for conferences, networking mixers, weddings, and corporate gatherings, this technology simplifies introductions, helps attendees remember key details, and significantly enhances the event experience. By making interactions more efficient and memorable, it fosters stronger relationships and ensures important connections are not lost. Smart glasses recognize individuals through name tags, facial recognition, or other identifiers, and users can add notes or preferences to profiles. These insights are securely stored and synchronized in real time, making them easily accessible to others during the event.

The present invention revolutionizes travel and hospitality by enhancing guest satisfaction and ensuring service consistency through real-time access to guest preferences using smart glasses. Hospitality staff can tailor their service to individual needs, providing seamless and personalized experiences. The technology enables staff to view guest profiles, including room settings, dining preferences, and special requests, and to update these profiles with new information or feedback, which is instantly synchronized across all locations. Ideal for hotels, resorts, cruise lines, and travel agencies, it enhances guest interactions at check-in, during their stay, and at checkout, delivering personalized attention and efficient service across multiple locations. By anticipating guest needs, resolving issues promptly, and offering high-quality service throughout the guest journey, this technology boosts guest satisfaction and loyalty. Smart glasses display detailed guest profiles and preferences, allowing staff to access and update relevant information in real time. These updates are synchronized across systems, ensuring consistent, tailored service at every touchpoint, whether at a single property or across a global network.

The present invention revolutionizes tourism services by transforming traditional sightseeing into an interactive and collaborative experience, enabling tourists to share and access real-time insights. Using smart glasses or mobile devices, tourists can enhance their exploration with live information, historical context, and recommendations from fellow travelers. The technology overlays real-time insights on landmarks, monuments, and popular attractions, allowing tourists to add their own observations, share personal experiences, and highlight interesting facts, creating a dynamic and engaging environment. Ideal for guided tours, sightseeing, and group travel, it enriches visits to historical sites, museums, nature reserves, and city tours by providing interactive and educational content. Tourists can exchange recommendations and tips, fostering social interaction and community engagement. By offering real-time information and encouraging contributions, the technology enhances the sightseeing experience, boosts satisfaction, and enriches the educational value of tours. Smart glasses or smartphones use object recognition to identify landmarks and overlay relevant insights in real time, allowing tourists to add voice-or text-based notes. These contributions are instantly synchronized across the system, making them accessible and visible to all users, fostering a shared and interactive tourism experience.

The present invention transforms cultural experiences by enhancing visitor engagement and learning through interactive, real-time access to information, fostering dynamic cultural exchange. Using smart glasses or smartphones, visitors can explore cultural sites, exhibits, and performances with live insights that enrich their understanding of history, art, and traditions. The technology overlays real-time information, such as historical context, artist details, and cultural significance, on exhibits, artworks, or live performances. Visitors can contribute their own insights, share experiences, or add new observations, creating a collaborative and interactive environment. Ideal for museums, galleries, cultural heritage sites, and live performances, this technology provides deeper insights into art pieces, landmarks, and cultural practices while encouraging meaningful exchange among visitors. By offering personalized and self-paced exploration, it makes cultural experiences more engaging, informative, and interactive, empowering visitors to contribute to collective knowledge and fostering a deeper connection with cultural heritage. Smart glasses or smartphones recognize exhibits, artworks, or performances and overlay relevant insights in real time. Visitors can interact with this content, add their interpretations, and share observations, which are instantly synchronized across the system, enriching the cultural experience for all.

The present invention revolutionizes law enforcement by improving identification and enhancing the efficiency of suspect tracking through real-time access to critical information. Using smart glasses equipped with facial recognition systems, officers can instantly identify suspects, access background details, and update profiles, enabling faster decision-making and improving investigations. The technology allows officers to store and retrieve suspect information, track movements across various locations, and respond promptly to dynamic situations. Ideal for investigations, patrolling, and surveillance operations, this technology enhances suspect identification during traffic stops, crowd monitoring, and field investigations. It is particularly effective for managing fugitive searches and tactical operations, providing officers with real-time insights and collaboration capabilities. By streamlining suspect tracking and data retrieval, it improves law enforcement efficiency and enhances officer safety by providing immediate access to critical details. Smart glasses identify suspects by analyzing facial biometrics and overlaying associated insights in real time. Officers can update profiles or create new entries for unrecognized suspects, with all updates synchronized across the system, ensuring all officers have access to the latest information for coordinated and effective operations.

The present invention transforms community policing by fostering trust and enhancing real-time response through the use of smart glasses. Officers can provide and access critical insights about individuals, vehicles, or objects within the community, promoting transparency, accountability, and efficient response. By associating insights with recognized community elements, law enforcement can update or act upon information in real time, ensuring all department members stay informed and coordinated. Ideal for community policing efforts, this technology strengthens relationships between law enforcement and residents by improving patrolling, public safety programs, and neighborhood outreach. Officers gain immediate access to historical data and real-time feedback, enabling quicker and more effective responses. By promoting positive engagement and demonstrating accountability, this technology builds public trust and supports safer communities. Smart glasses equipped with recognition technology can identify elements such as individuals'faces, vehicles, or objects, displaying associated insights instantly. Officers can view or update these insights as needed, with changes synchronized across the system. This ensures seamless collaboration, timely responses, and enhanced transparency in community policing efforts.

The present invention transforms surveillance by enhancing security operations through real-time insights and automatic information retrieval about individuals, significantly improving situational awareness and response efficiency. Using smart glasses equipped with facial recognition, security personnel can quickly identify individuals, access critical data, and share insights during potential security threats. The technology allows teams to annotate and associate information with a suspicious individual, enabling other team members to view and update these insights when encountering the same person. This collaborative approach improves decision-making and accelerates response times. Ideal for public spaces, commercial buildings, and large events, it significantly enhances security in shopping malls, airports, government buildings, and entertainment venues by enabling proactive threat responses. By reducing response times and increasing operational efficiency, this technology ensures a safer environment for people and property. It empowers security teams to act swiftly based on the most up-to-date information, improving surveillance effectiveness and operational coordination. Smart glasses equipped with facial recognition capture an individual's face, allowing security personnel to associate it with insights. These insights are instantly synchronized across the team, ensuring all members stay informed and can respond effectively when the individual is encountered again.

The present invention revolutionizes security and access control by leveraging facial recognition and real-time insights to ensure accurate and efficient identity verification. Using smart glasses, security personnel can instantly verify identities, provide insights about access points, and securely retrieve user credentials, streamlining the process of managing restricted access. The technology allows for real-time facial recognition and annotation of access data, enabling security teams to retrieve verified credentials and ensure that only authorized individuals can enter restricted areas. It enhances accuracy, reduces manual checks, and speeds up the verification process while maintaining high levels of security. Ideal for high-traffic areas, office buildings, restricted zones, and facilities requiring tight access control, this technology is particularly effective in environments such as corporate offices, government buildings, airports, and research labs. By simplifying authentication and improving user convenience, it reduces bottlenecks and enhances overall security operations. Smart glasses equipped with facial recognition technology scan individuals as they approach an access point, retrieve associated insights, and allow security personnel to grant or deny access based on the data. Security staff can update the insights with feedback in real time, ensuring the system remains accurate and up to date across all access points.

The present invention transforms transportation by streamlining the travel experience, improving operational efficiency, and enhancing customer satisfaction. Using smart glasses, transportation staff can access real-time passenger information, provide personalized assistance, and manage key operational data, ensuring a smoother and more efficient travel process. The technology enables transportation personnel to access details such as flight or train schedules, boarding information, and baggage handling directly through smart glasses. It allows staff to deliver personalized service, assist passengers promptly, and update insights in real time. Ideal for airports, train stations, bus terminals, and transportation hubs, it enhances coordination among staff, reduces wait times, and minimizes delays, ensuring passengers receive efficient and personalized assistance. By providing real-time access to travel data, this technology improves operational efficiency and helps resolve issues faster, creating a seamless and satisfying experience for travelers. Smart glasses recognize passengers by associating their facial biometrics with ticket information, displaying relevant details as insights when they approach a staff member. This allows staff to assist passengers, update information, and ensure a more efficient and personalized travel experience.

The present invention revolutionizes lost and found security by enabling the accurate and efficient identification of lost individuals, ensuring timely assistance and family reunification. Using smart glasses equipped with facial recognition, personnel can instantly retrieve information about lost persons, verify their identities, and coordinate reunification efforts smoothly. The technology integrates facial recognition and real-time data retrieval to locate lost individuals quickly. Staff can add key details or personal information as insights, which are shared with team members to expedite the process of matching individuals with their families or guardians. Ideal for high-traffic environments such as amusement parks, airports, shopping malls, and large public events, this technology enhances safety and efficiency by streamlining the identification and tracking of lost children or individuals. By ensuring quick and accurate resolutions, this technology promotes a sense of security for families and staff, reduces the stress and anxiety of searching for lost persons, and enhances overall customer satisfaction. Smart glasses recognize individuals in the area, associate their profiles with relevant insights, and display this information in real time. These insights are instantly synchronized across the security team, ensuring coordinated efforts and timely reunification.

The present invention transforms manufacturing by enhancing on-site and remote collaboration, boosting project efficiency with real-time insights on machinery, materials, and production processes. Using smart glasses, teams can document changes, track progress, and communicate seamlessly, ensuring improved coordination and operational efficiency. The technology allows technicians to annotate machinery with performance notes, maintenance history, and issue reports, which are automatically shared across the team. This enables team members to learn from past experiences, apply solutions to similar problems, and streamline troubleshooting. Ideal for production lines, maintenance departments, and plants, it improves processes by allowing technicians to document issues directly on equipment, share insights in real time, and access historical maintenance data. By fostering collaboration and knowledge sharing, this technology reduces downtime, accelerates response times, and ensures all team members have access to the latest updates, significantly improving overall efficiency. Smart glasses capture live data from machinery and enable technicians to provide insights, solutions, or maintenance steps directly on the equipment. These insights are synced across the system, ensuring they are accessible for viewing and updates by other technicians, creating a seamless and collaborative workflow.

The present invention revolutionizes the construction industry by enhancing on-site and remote collaboration, boosting project efficiency with real-time insights into construction progress, materials, and blueprints. Using smart glasses, construction teams can seamlessly document changes, track progress, and communicate updates, ensuring better coordination across all stakeholders. The technology allows workers to annotate blueprints, construction materials, and equipment with real-time notes, enabling instant feedback and seamless collaboration between on-site teams and remote project managers. Ideal for construction sites, renovation projects, and large-scale infrastructure developments, it streamlines tracking material usage, documenting plan changes, and sharing updates to keep all team members aligned. By improving communication and collaboration, this technology reduces errors, minimizes delays, and accelerates decision-making. A centralized, easily accessible record of updates ensures clarity, significantly lowering the risk of miscommunication. Smart glasses capture live visuals of materials, blueprints, and on-site activities, allowing workers to add detailed insights via voice. These updates are instantly uploaded to the cloud and synchronized across devices, enabling real-time feedback and efficient coordination for all project participants.

The present invention transforms maintenance and repair operations by enhancing efficiency and promoting knowledge sharing through real-time insights and collaboration. Using smart glasses, technicians can document repair processes, share solutions, and access real-time updates, improving troubleshooting and reducing downtime. The technology enables technicians to annotate equipment with detailed insights, including issues, repair steps, and maintenance history. These insights are synchronized across devices, allowing for collaborative problem-solving and instant access to relevant information. Ideal for maintenance departments, repair shops, and field service operations, this technology streamlines the repair process by enabling the documentation and sharing of troubleshooting steps, common solutions, and maintenance tips. By providing instant access to the latest repair data and solutions, this technology improves efficiency, reduces the learning curve for new technicians, and significantly minimizes equipment downtime. Smart glasses capture visuals of equipment parts, enabling technicians to provide insights about issues, repair processes, and parts used. These updates are instantly synchronized across the system, ensuring all team members can access and update the information, fostering a collaborative and effective maintenance environment.

The present invention transforms the smart home experience by providing real-time insights into devices and appliances, fostering collaboration, optimizing usage, and enhancing safety and efficiency. Using smart glasses equipped with object recognition, users can identify smart devices and appliances, share performance notes, troubleshoot issues, and provide updates that benefit the broader smart home ecosystem. Homeowners can annotate devices with insights related to performance, issues, or troubleshooting, which are uploaded to the cloud and synchronized in real time. These insights are visible to other users in the smart home community, enabling feedback and updates that promote collaboration and enhance the overall experience. Ideal for homeowners, smart device manufacturers, home automation companies, property managers, and technical support teams, this technology supports proactive maintenance, quick troubleshooting, and efficient device optimization. By promoting shared insights, the technology helps users discover features, reduce energy consumption, and improve safety, making smart homes more efficient and user-friendly. Smart glasses with object recognition identify the device or appliance in use, allowing users to provide or access insights instantly. These updates create a shared knowledge base, empowering users to maximize the value of their smart home systems.

The present invention revolutionizes community living by providing real-time insights into shared resources such as facilities, utilities, and public amenities, fostering collaboration and optimizing resource management. Using smart glasses or mobile devices, residents can share maintenance updates, feedback, and improvement suggestions for shared spaces like recreational facilities, public areas, and utilities. These insights are uploaded to the cloud in real time and made accessible to all community members and stakeholders, enabling collective feedback and actionable responses. Ideal for residential communities, property managers, facility maintenance teams, urban developers, and local authorities, this technology enhances collaboration, promotes efficient resource usage, and ensures proactive maintenance. By streamlining communication and fostering a sense of shared responsibility, it creates safer, more connected, and sustainable communities. Residents can use the technology to report issues, suggest improvements, or track maintenance updates. The system also provides valuable analytics on usage patterns, maintenance trends, and community interactions. These insights help community managers optimize resource allocation, improve service delivery, and plan future upgrades effectively, ensuring a seamless and engaging community experience.

The present invention transforms smart cities by providing real-time insights into infrastructure, public transportation, and city services, fostering collaboration and enhancing urban living. Citizens can use smart glasses or mobile devices to share updates on road conditions, transit systems, or utilities, report issues, and offer actionable suggestions to improve city operations. These insights are instantly uploaded to the cloud and made accessible to municipal authorities, city planners, and fellow citizens, enabling collective problem-solving and swift action. Ideal for city planners, municipal authorities, public transportation operators, and infrastructure management teams, this technology promotes smarter urban development and more efficient operations. It empowers citizens to actively engage in their communities, contributing to better infrastructure management, improved public safety, and sustainable urban planning. The system enables faster issue resolution and enhances collaboration by synchronizing insights in real time with relevant city departments or community groups. Smart glasses or mobile devices equipped with advanced object recognition allow users to annotate urban elements, such as roads or traffic systems, creating a seamless flow of information. This proactive approach reduces response times, optimizes resource allocation, and ensures cities can evolve to meet the needs of their communities.

The present invention revolutionizes personal telecommunications fraud detection by utilizing smart glasses equipped with integrated voice biometric software to analyze and identify fraudulent calls. By capturing unique voice patterns, the system detects suspicious or fraudulent calls, even when the caller's phone number or name is altered, as is common in fraudulent schemes. The voice biometric software analyzes the caller's voice in real time, allowing users to add insights about suspicious behavior. These insights are synchronized across devices, ensuring that when another user receives the same call, alerts and insights appear on their smart glasses. This proactive approach detects fraud whether the call originates from a phone, VoIP, or AI-generated source, providing immediate warnings and enhancing security. Ideal for personal fraud prevention, this technology identifies fraud indicators as soon as the caller speaks, alerting users to potential threats before any fraudulent activity occurs. When a call is received, the voice biometric software analyzes the caller's voice, detects fraud-related patterns, and enables users to provide comments and share insights. These insights are instantly synchronized, ensuring others are alerted to the fraudulent activity, fostering a collaborative and effective fraud detection system.

The present invention revolutionizes fraud detection for businesses and call centers by utilizing smart glasses with integrated voice biometric software to recognize caller voice biometrics in real time. It identifies suspicious calls regardless of caller ID manipulations, VoIP usage, or AI-generated voices, enabling organizations to prevent fraud effectively and collaboratively. Designed for use within a business or call center, the system allows staff members to provide and share insights about a caller's voice, adding comments or alerting notes. These insights are instantly available to all team members when a call from the same individual is received. Ideal for phones, VolP, and AI-generated voice communications, this technology analyzes calls in real time, detecting suspicious behavior before fraud occurs and enabling swift action. By proactively identifying fraud patterns, targeting trends, and suspicious caller behavior, the technology helps businesses optimize their fraud prevention strategies, improve response times, and significantly reduce the risk of financial losses. Smart glasses or smartphones associate a caller's voice with shared insights, which appear whenever the person calls again. Staff can update insights to crowdsource information about the caller's suspicious history, creating a comprehensive alert system. This approach not only protects organizations from financial harm but also enhances their ability to adapt to evolving fraud tactics, ensuring long-term security.

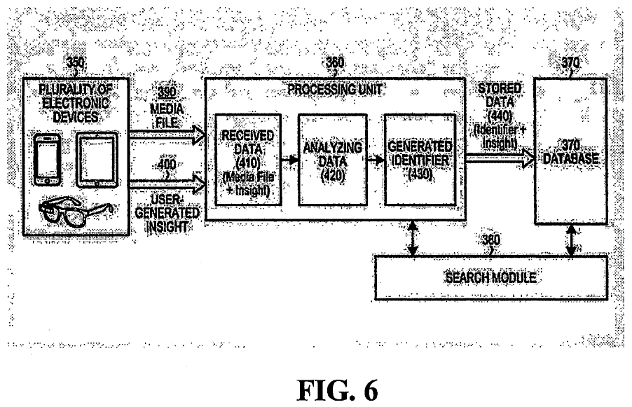

As described herein, in one embodiment, the present invention provides a collaborative, crowd-sourced media insight system. The system comprises a plurality of electronic devices, a processing unit, a database, and a search module. Each of the plurality of electronic devices is configured to capture a media file representing a real-world environment and to associate the media file with a user-generated insight. The processing unit is configured to: (a) receive the media file and the associated insight from a first electronic device, (b) analyze the media file to generate at least one identifier representative of content within the media file, and (c) store the at least one identifier and the associated insight in a database. The database associates each identifier with a set of insights received from one or more users. The search module is configured to: (a) receive a query media file from a second electronic device, (b) generate a query identifier based on content analysis of the query media file, (c) retrieve from the database one or more insights associated with the query identifier, and (d) transmit the retrieved insights to the second electronic device for presentation via a display or an audio interface. FIG. 6 illustrates a block diagram showing the system of the present invention according to one embodiment. The block diagram includes a plurality of electronic devices 350, a processing unit 360, a database 370, and a search module 380. Each of the plurality of electronic devices is configured to capture a media file 390 and associate it with a user-generated insight 400. The processing unit is configured to perform three functions: receiving the data 410 comprising the media file and the associated insight from the electronic device, analyzing the data 420 to generate at least one identifier 430, and storing the data 440 comprising the at least one identifier and the associated insight in the database.

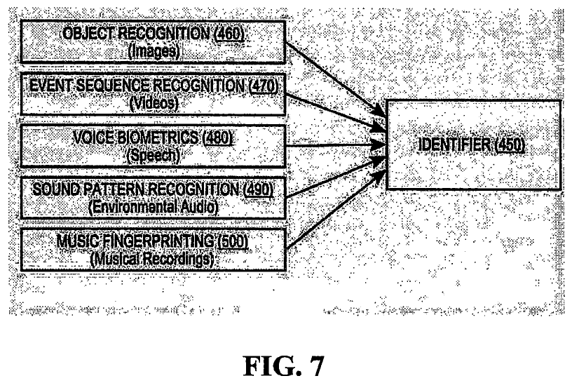

The electronic devices of the present invention may comprise smart glasses, smart contact lenses, smartphones, tablets, or wearable computers. Additionally, a combination of these devices may operate in conjunction. The media file may comprise a picture, a video, or an audio recording. The user-generated insight may comprise text, an image, a video, an audio recording, or an augmented reality annotation. The processing unit comprises a server equipped with a computer vision program configured to analyze pictures and videos, or an AI audio processing program configured to analyze voice, sound, or music recordings. The processing unit may be further configured to filter the retrieved insights based on at least one of: a geographic location of the electronic device, user demographic data, an environmental context derived from the media file, or temporal data. The presentation of the retrieved insights on the electronic device may be performed via a heads-up display, a screen, or an auditory interface integrated into the electronic device. The identifier may be generated using at least one of: object recognition for images, event sequence recognition for videos, voice biometrics for speech, sound pattern recognition for environmental audio, or music fingerprinting for musical recordings. As illustrated in FIG. 7, an identifier 450 is generated using object recognition 460 for images, event sequence recognition 470 for videos, voice biometrics 480 for speech, sound pattern recognition 490 for environmental audio, or music fingerprinting 500 for musical recordings. The system may utilize one or more of these recognition techniques to generate the identifier. In one embodiment, the system is configured to perform continuous media capture of the surrounding environment. In such an embodiment, insights are automatically transmitted to a user upon the identification of dynamically detected contextual triggers derived from the captured media. The database is configured to aggregate insights contributed by a plurality of distinct users for a specific identifier, thereby establishing a comprehensive crowdsourced knowledge base associated with the media content. Additionally, the electronic device is configured to enable a user to provide feedback regarding a retrieved insight. This feedback is subsequently stored in the database and linked to the corresponding unique identifier, thereby refining the accuracy and relevance of the crowdsourced knowledge base.

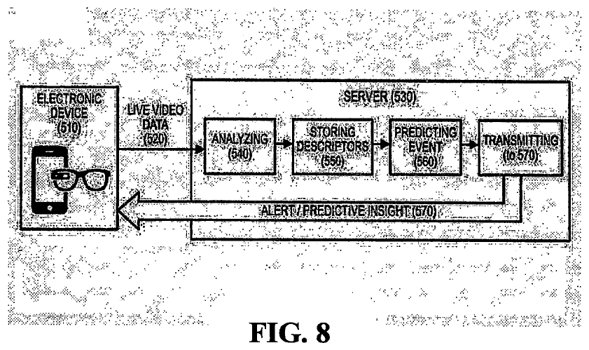

In another embodiment, the present invention discloses a real-time predictive insight system comprising an electronic device configured to stream live video data to a server. The server is configured to perform four functions: (1) analyzing the live video data using computer vision and audio recognition to generate scene-specific content descriptors; (2) storing successive content descriptors representing successive scenes in a database; (3) predicting a subsequent scene or event based on stored content descriptor patterns using a machine learning model; and (4) transmitting an alert or a predictive insight to the electronic device based on the prediction. FIG. 8 illustrates an electronic device 510 streaming live video data 520 to a server 530. The server is configured to perform four functions: analyzing 540 the live video data, storing successive content descriptors 550, predicting a subsequent scene or event 560, and transmitting an alert or a predictive insight 570 to the electronic device. It is important to note that the electronic device may comprise smart glasses or smart contact lenses. The server may utilize AI vision technology to recognize visual elements of the scenes and AI audio technology to recognize speech within the audio. The machine learning model may comprise a Large Language Model (LLM) or a sequence prediction model trained to predict the next scene based on historical sequences of content descriptors stored in the database. The alert or predictive insight is transmitted upon detection of a predetermined condition selected from the group consisting of: a dangerous situation, a humorous event, a decision-point, a specified emotional state, or a user-preference match. The alert or predictive insight is presented on a display of the electronic device. The alert or predictive insight may be presented as textual information providing feedback, a suggestion, or a warning to the user. Additionally, the alert or predictive insight may be presented as a visual overlay comprising an image, a video, an animation, text, or an augmented reality object that provides information, instructions, or suggestions to the user. Furthermore, the predictive insight system may be integrated with the collaborative insight system, such that the database of stored insights is utilized by the machine learning model to enhance the prediction of subsequent scenes or events.

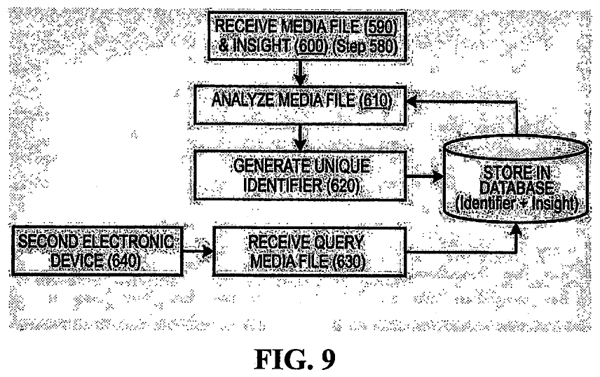

In yet another embodiment, the present invention discloses a method for crowd-sourced media content creation and retrieval. The method begins by receiving, at a processing unit, a media file and an associated insight from a first electronic device. The media file is then analyzed to generate a unique identifier representing the content of the media file. Following this analysis, the unique identifier and the associated insight are stored in a database. The method further involves receiving, at the processing unit, a query media file from a second electronic device. A query identifier is subsequently generated based on the content of the query media file. Then, one or more stored insights corresponding to the query identifier are retrieved from the database. Finally, the retrieved insights are transmitted to the second electronic device. FIG. 9 illustrates a flowchart of this method. As depicted, the method comprises receiving 580 a media file 590 and an associated insight 600. The media file is analyzed 610 to generate a unique identifier 620. Subsequently, the unique identifier and the associated insight are stored in a database. The method further entails receiving a query media file 630 from a second electronic device 640. A query identifier 650 is generated based on the content of the query media file. Thereafter, stored insights 660 corresponding to the query identifier are retrieved from the database. Finally, the retrieved insights are transmitted 670 to the second electronic device.

While the present invention has been described with reference to specific embodiments and examples, it is to be understood that these are illustrative only and are not intended to limit the scope of the invention. Many modifications, variations, and alternative constructions will be apparent to those skilled in the art without departing from the spirit and scope of the invention as set forth in the claims. For example, although specific electronic devices such as smart glasses or smartphones have been described, the principles of the present invention may be applied to other current or future computing devices capable of capturing and processing media. Furthermore, the steps of the disclosed methods may be performed in a different order or in parallel, and certain components may be combined or separated, while still achieving the same results. Accordingly, the scope of the invention should be determined not by the specific embodiments illustrated, but by the appended claims and their legal equivalents.

1. A collaborative, crowd-sourced media insight system, comprising:
a plurality of electronic devices, each configured to capture a media file representing a real-world environment and to associate the media file with a user-generated insight;
a processing unit configured to:
(a) receive the media file and the associated insight from a first electronic device,
(b) analyze the media file to generate at least one identifier representative of content within the media file, and
(c) store the at least one identifier and the associated insight in a database;
wherein the database associates each identifier with a set of insights received from one or more users; a search module configured to:
(a) receive a query media file from a second electronic device,
(b) generate a query identifier based on content analysis of the query media file,
(c) retrieve from the database one or more insights associated with the query identifier, and
(d) transmit the retrieved insights to the second electronic device for presentation via a display or an audio interface.

2. The system of claim 1, wherein the electronic devices comprise smart glasses, smart contact lenses, smartphones, tablets, or wearable computers.

3. The system of claim 1, wherein the media file is a picture, a video, or an audio recording.

4. The system of claim 1, wherein the user-generated insight comprises text, an image, a video, an audio recording, or an augmented reality annotation.

5. The system of claim 1, wherein the processing unit comprises a server equipped with a computer vision program for analyzing pictures and videos, or an AI audio processing program for analyzing voice, sound, or music recordings.

6. The system of claim 1, wherein the processing unit is further configured to filter the retrieved insights based on at least one of: geographic location of the electronic device, user demographic data, and environmental context derived from the media file, or temporal data.

7. The system of claim 1, wherein the presentation of the retrieved insights on the electronic device is performed via a heads-up display, a screen, or an auditory interface integrated into the electronic device.

8. The system of claim 1, wherein the at least one identifier is generated using at least one of: object recognition for images, event sequence recognition for videos, voice biometrics for speech, sound pattern recognition for environmental audio, or music fingerprinting for musical recordings.

9. The system of claim 1, wherein the system is further configured for continuous media capture, and wherein insights are transmitted to a user based on dynamically detected contextual triggers derived from the captured media.

10. The system of claim 1, wherein the database is configured to store insights contributed by a plurality of users for a given identifier, thereby creating a crowdsourced knowledge base associated with media content.

11. The system of claim 1, wherein the electronic device is further configured to allow a user to provide feedback on a retrieved insight, and wherein said feedback is stored in the database and associated with the corresponding identifier.

12. A real-time predictive insight system, comprising: an electronic device configured to stream live video data to a server; the server configured to:
(a) analyze the live video data using computer vision and audio recognition to generate scene-specific content descriptors,
(b) store successive content descriptors representing successive scenes in a database,
(c) predict a subsequent scene or event based on stored content descriptor patterns using a machine learning model, and
(d) transmit an alert or a predictive insight to the electronic device based on the prediction.

13. The system of claim 12, wherein the electronic device comprises smart glasses or smart contact lenses.

14. The system of claim 12, wherein the server utilizes AI vision technology to recognize visual elements of the scenes and AI audio technology to recognize speech within the audio.

15. The system of claim 12, wherein the machine learning model comprises a Large Language Model (LLM) or a sequence prediction model trained to predict the next scene based on historical sequences of content descriptors stored in the database.

16. The system of claim 12, wherein the alert or predictive insight is transmitted upon detection of a predetermined condition selected from the group consisting of: a dangerous situation, a humorous event, a decision-point, a specified emotional state, or a user-preference match.

17. The system of claim 12, wherein the alert or predictive insight is presented on a display of the electronic device.

18. The system of claim 12, wherein the predictive insight system is integrated with the system of claim 1, such that the database of stored insights is utilized by the machine learning model to enhance the prediction of subsequent scenes or events, and the alert or predictive insight is presented as textual information providing feedback, a suggestion, or a warning to the user.

19. The system of claim 17, wherein the alert or predictive insight is presented as a visual overlay comprising an image, a video, an animation, text, or an augmented reality object that provides information, instructions, or suggestions to the user.

20. A method for crowd-sourced media content creation and retrieval, comprising: receiving, at a processing unit, a media file and an associated insight from a first electronic device; analyzing the media file to generate a unique identifier representing content of the media file; storing the unique identifier and the associated insight in a database; receiving, at the processing unit, a query media file from a second electronic device; generating a query identifier based on content of the query media file; retrieving from the database one or more stored insights corresponding to the query identifier; and transmitting the retrieved insights to the second electronic device.
